(19) United States
(12) Patent Application Publication
(10) Pub. No.: US 2019/0295798 A1
(43) Pub. Date: Sep. 26, 2019

(54) FUSE COMPONENT

(71) Applicant: INTER CONTROL Hermann Köhler Elektrik GmbH & Co. KG, Nuremberg (DE)

(72) Inventor: Peter PÖSSNICKER, Nuremberg (DE)

(73) Assignee: INTER CONTROL Hermann Köhler Elektrik GmbH & Co. K G, Nuremberg (DE)

(21) Appl. No.: 16/373,161

(22) Filed: Apr. 2, 2019

Related U.S. Application Data
(63) Continuation of application No. 15/566,109, filed on Oct. 12, 2017, now abandoned.

(30) Foreign Application Priority Data
Apr. 15, 2015 (DE) 20 2015 101 840.1

(51) Int. Cl. H01H 85/175; H01H 85/157; H01H 85/041

(52) U.S. Cl. CPC H01H 85/1755; H01H 85/157; H01H 2085/0414; H01H 85/0418; H01H 85/0411; H01H 85/175

(57) ABSTRACT

A fuse component (1) has a fuse element (2). The fuse element (2) is located inside an isolating body (3) and the fuse element (2) extends between the two end faces of the isolating body (3). Each of the end faces of the isolating body (3) are closed by electrical conductive end caps (4) and the end caps (4) are in electrical contact with the fuse element (2). The isolating body (3) includes at least two shells (5a, 5b); at least in the region of the end caps (4), and the shells (5a, 5b) in the assembled state form a channel (6) to receive the fuse element (2).

This application is a Continuation of U.S. patent application Ser. No. 15/566,109, filed 12 Oct. 2017, which is a National Stage Application of PCT/EP2016/052220, filed 3 Feb. 2016, which claims benefit of Serial No. 20 2015 101 840.1, filed 15 Apr. 2015 in Germany, and which applications are incorporated herein by reference. To the extent appropriate, a claim of priority is made to each of the above disclosed applications.

The present invention relates to a fuse component, such as a current fuse for overcurrent protection. Preferably, the above invention relates to a so-called miniature fuse for surface mounting from the group of miniature fuses in accordance with IEC 60127 Part 4, with main applications for DC voltages.

### TECHNICAL BACKGROUND

Fuse elements are overcurrent protection devices that interrupt an electric circuit due to melting of a fuse element as soon as the current exceeds a certain value for a predetermined time.

Miniature fuses are used as device protection fuses, for example in power supplies, television and radio equipment, and measuring instruments. The basic construction includes two connection contacts (end caps) connected by the actual fuse element in the form of wire or conductive (metal) layers, which are sheathed by an electrically insulating housing such that hot vapors or sparks at the moment of tripping of the fuse pose no danger to the surrounding components or fuse carriers, such as fuse holders and printed circuit boards. The parameters of such miniature fuses include the rated current, rated voltage, tripping characteristics, and breaking capacity, especially the rated breaking capacity. So as to ensure a high breaking capacity in miniature fuses, the interior space of the insulating housing containing the fuse element is filled with an extinguishing medium, for example sand. If the fuse element burns out, an arc is formed that runs in the direction of the end caps. The pulse-like energy delivery produces a plasma arc based on impact ionization of the (gas) molecules surrounding the fuse element, which is accompanied by intense heating and pressure build-up in the interior space of the capsule. Due to the pressure increase, the arc is extinguished as soon as the arc voltage exceeds the driving source voltage that is applied to the terminal contacts of the fuse. A defined, sudden pressure increase is therefore desired to a certain degree, the maximum pressure stability of the fuse housing. To set a defined pressure increase, pressure compensation channels can be provided, which are supposed to prevent a too-sudden pressure increase. The pressure compensation channels serve to limit overpressure spikes in the interior space in a targeted manner.

### Closest Prior Art

A fuse component according to the preamble of claim 1 is known from EP 1455 375 B1. This known fuse component comprises a fuse element which is arranged approximately diagonally in the interior of a cylindrical tube and is guided at its ends around the front sides of the tube, so that the ends of the fuse element rest on the outer wall of the tube. Both ends of the tube are provided with an elastically deformable seal plug, which is press-fitted into the respective end opening of the tube. The sealing plug presses a short section of the fuse element onto the inner wall of the tube, whereby pressure equalization channels are formed. These channels bring about a slow equalization of the interior pressure so that a sudden increase in pressure in the interior can have an extinguishing effect on the fuse element. Plastic plates are placed in the respective end faces of the tube and sealed with electrically conductive end caps so that the end caps are in electrical contact with the fuse element.

### Problem of the Present Invention

The problem of the present invention is to make a novel fuse component available that permits simplified installation with greater operating stability.

### Solution to the Problem

The above problem is solved by a fuse component according to the invention per the features of claim 1.

Useful embodiments of the invention are claimed in the dependent claims.

The fuse component according to the invention per claim 1 permits an especially simple installation which is accessible to an automated process. According to the invention the insulating body is divided longitudinally. It preferably comprises several, for example two, shells running longitudinally that are made from an electrically insulating material. This makes it possible to insert the fuse element in a simple manner into one of the shells, and to assemble this with additional shell(s) to complete the insulating body. In the respective end region of the insulating body, the shells form a channel which encloses the fuse element as far as the respective end cap. Preferably toward this end at least one shell, preferably each of the shells, has a longitudinal recess. The fuse element in this way can initially be inserted in the recess of the one shell. Then the shell is assembled with at least one further shell, so that the fuse element preferably is received in a form-fitting manner in the channel thereby formed. This makes possible especially rapid as well as automated manufacture of the insulating body with an internal fuse element.

Advantageously the channel runs parallel to the longitudinal direction of the insulating body, preferably along the middle axis of same. This arrangement is easily accomplished by means of the design according to the invention. At the same time this ensures that the fuse element always has the greatest possible separation from the inner walls of the insulating body. Contacting of the fuse element with the side walls of the insulating body is avoided during the loading phases of the fuse, in which the fault current, which ultimately leads to tripping of the fuse, builds up slowly, usually in the form of a rising ramp, so that due to the material elongation or stretching of the fuse component caused by fixation to the end caps and the defined length of the insulating body, a bend is formed in the interior space of same.

Advantageously the shells possess interlocking shapes and through their symmetry form a rotationally symmetric unit.

In particular the shells in the assembled state are axially fixed to one another by means of at least one stage that runs transversely to the longitudinal axis. This facilitates assembly of the shells, as the shells mutually align one another with respect to their longitudinal position during assembly. Since the respective shell has an at least substantially L-shaped transverse form, in addition effective positioning in the circumferential direction is facilitated during assembly.

Advantageously a lug provided on the one shell engages a recess provided on the other shell. This supports well-positioned assembly of the individual shells with one another.

Advantageously the insulating body is formed by two longitudinal shells or half shells.

In an advantageous manner the shells are injection-molded parts made of injection-moldable material. The material used is polyamide, preferably heat-resistant polyamide of class PA6. This material is injection-moldable and in addition possesses an advantageous self-extinguishing property. However other plastic granulates are also conceivable whose shape stability is longer in a temperature range of more than 200° C. and whose flame retardant properties may be found in the classification UL-94.

Preferably the shells possess an identical shape. In this way the production costs can be further lowered.

The fuse element preferably has angled, in particular flattened ends. The fuse element can also be prefabricated with these angled flattened ends. The angled ends are advantageous because after insertion of the fuse element and assembly of the half shells, the respective end of the fuse element can be pressed without further processing with the subsequently mounted end caps in an intermediate position with respect to the front side of the insulating body and thus in electrical contact with the end, and subsequent axial shaping of the fuse element is avoided.

Preferably the shells are directly and inseparably connected to one another by means of fasteners. In particular the shells can also be connected to one another by ultrasound welding or similar technical connection means.

Advantageously in the end regions of the half shells, at least one recess is provided, preferably in the form of at least one groove running along the circumference transversely to the longitudinal axis of the fuse component. In this way it is possible to securely fix the end cap after its mounting on the insulating body by means of a lug engaging with the recess.

Preferably the recess or groove serves to press material of the end cap, preferably by crimping, into the region of the recess or groove, and thus in addition to the axial stabilization of the housing halves, also provides lateral fixation in the direction of the guide shaft assembly.

Preferably the channel received the fuse element without a gap.

According to a special embodiment, the end cap and the fuse element are electrically contacted with one another by means of laser soldering, resistance soldering, or induction soldering. This involves indirect heating of the material surface, which results in a braze. This connection is achieved without additional materials such as solder and flux and thus avoids residue in the form of organic masses that can negatively affect the arc, so that the burning duration or the pressure development can lead to an explosion of the fuse housing. The prerequisite for this is that the surfaces of the materials to be joined have similar characteristics. As regards thermal load and processing times in the manufacture of such fuses, tin surfaces on the fuse element and the end cap are to be preferred. Depending on the pressing force of the caps on the insulating body, the hard soldering process can be dispensed with, so that the durable flexibility of the insulating body exerts sufficient pressing force of the fuse element on the end cap. However, electrical stabilization of the fuse element on the cap should be sought, since any subsequent thermal load in the form of soldering of the fuse into the electrical circuits in some circumstances can alter the coupling so intensely that the use loses its specific properties.

In an especially advantageous manner, the two half shells in the assembled state with mounted end caps form a uniform cuboid insulating body while avoiding steps or recesses in the region of the transition from end cap to insulator. This ensures that a flat in particular planar mounting surface is formed between the end cap or insulating body and the respective application area, which is advantageous for contacting. In addition the use of fixing adhesives in the end cap region is avoided or at least considerably reduced.

### DESCRIPTION OF THE INVENTION WITH REFERENCE TO EXEMPLARY EMBODIMENTS

An advantageous embodiment of the present invention is explained more closely below with reference to drawing figures. For the sake of clarity repeating features are marked with a reference sign only once. In the drawings:

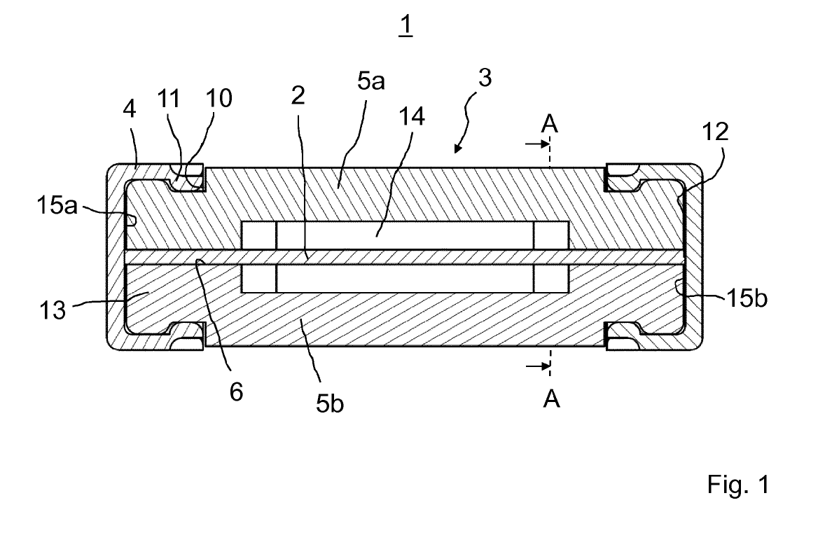

FIG. 1 is a longitudinal sectional view of a fuse component according to the invention.

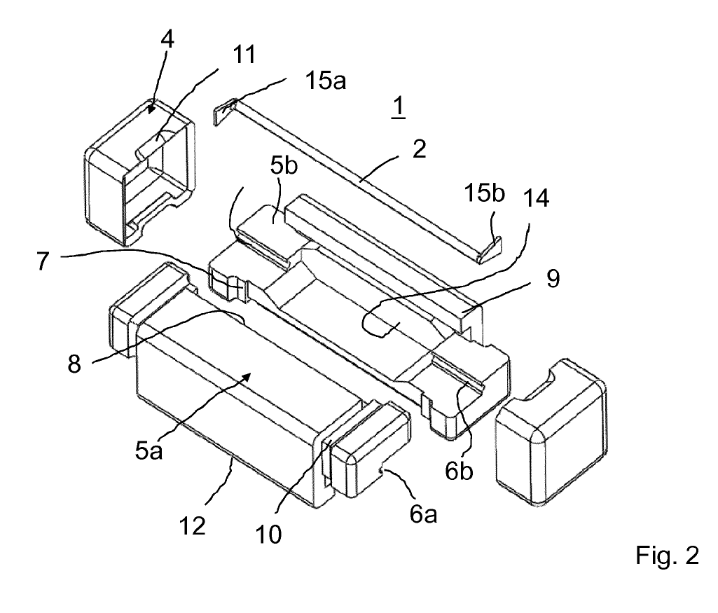

FIG. 2 is a exploded perspective view of the fuse component according to FIG. 1.

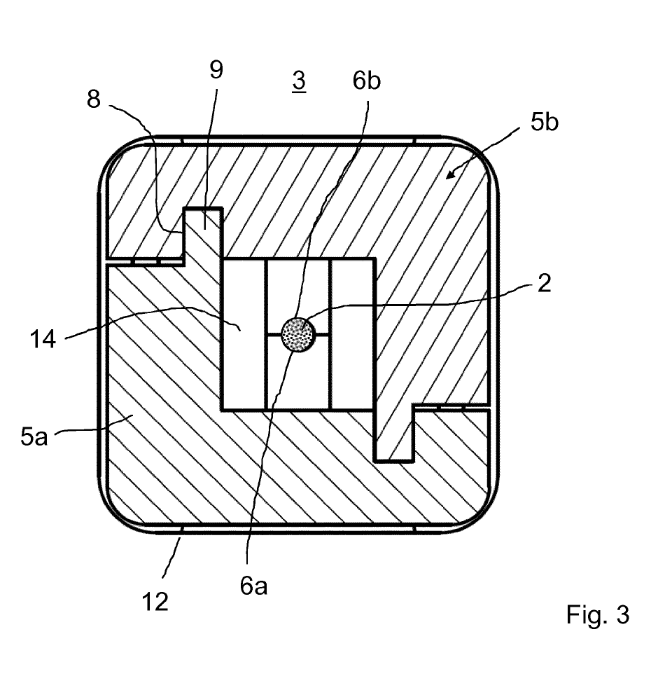

FIG. 3 is a partial section of the fuse component in the section plane A-A of FIG. 1 and

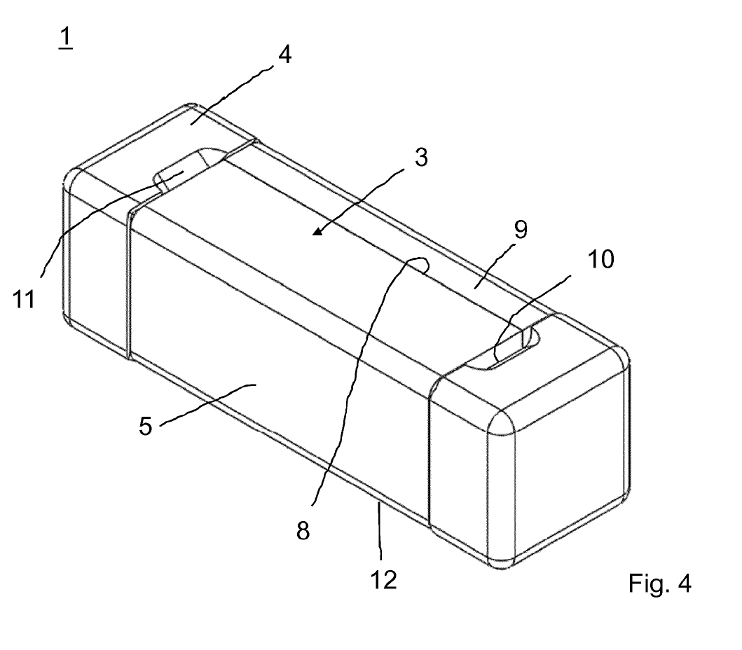

FIG. 4 is a perspective view of an embodiment of the fuse component according to the invention in the assembled state.

Reference sign 1 in FIG. 1 denotes the fuse component according to the invention in its entirety.

It is preferably a so-called miniature fuse according to the requirements of the underlying standard for fuses, IEC 60/127 Part 4. The fuse component 1 includes an insulating body 3 made of an electrically insulating material and two electrically conducting end caps 4 mounted on the respective end of the insulating body 3.

The insulating body 3 comprises two identical half shells 5a and 5b divided in the longitudinal direction, which joint form a cavity 14 as well as a channel adjoining each end of the cavity, which receives the fuse element 2 in a form-fitting manner. The channel 6 runs along the central axis of the insulating body 3 and in each case opens into the end face of the insulating body 3.

The insulating body 3 possesses a region 13 at its two end regions, which encloses the fuse element 2 in a form-fitting and preferably gap-free manner, and insulates the exposed region of the fuse element 2 in the cavity 14 from the associated end cap 4. This ensures that the arc cannot penetrate to the end cap, or effects fusing of the latter, so that arc plasma can escape from the fuse interior space causing further damage to nearby components.

In the region of the respective end cap 4 there is a recess 10 provided in the insulating body, which recess is engaged by the corresponding lug 11 of the respective end cap 4, and fixes the latter to the insulating body.

This fixation occurs advantageously in that the end cap 4 is crimped onto the end of the insulating body 3, that is, the material of the end cap 4 is pressed into the recess 10.

The insulating body 3 is formed in such a way that it forms a planar, end-face mounting surface 12 for the respective cap 4. A planar design of a mounting surface 12 of the insulating body 3 improves the contacting of the fuse element 2 with the respective end cap.

At its end faces, the fuse element 2, cf. also FIG. 2, has two angled, flattened end regions 15a and 15b, which are located between the respective end face 12 of the insulating body 3 and the respective cap 4 in the force fit. Alternatively or additionally, the end cap 4 as well as the respective end region 15a, 15b of the fuse element can be electrically contacted to one another by means of a soldering process, such as laser soldering, resistance soldering, or induction soldering.

FIG. 2 shows an exploded view of the individual parts of the fuse component shown in FIG. 1. The insulating body 3 is configured in this embodiment from two half shells 5a and 5b divided in the longitudinal direction.

Each of the two half shells 5a and 5b have a longitudinally extended, semicircular recess 6a, 6b, which together form the channel 6 for receiving the fuse element 2. From the view in FIG. 2, it further becomes plain that each half shell 5a, 5b has shaped elements that in interaction with the accordingly formed shaped elements of the adjacent half shell effect a form fit, which fixes the two half shells 5a, 5b to one another in the longitudinal direction and/or in the circumferential direction in the assembly position. Thus for example the region of the half shell 5b set back in the region of the step 7 is filled by an accordingly projecting region (not shown in FIG. 2) of the half shell 5b, thus ensured axial latching.

It is likewise plain from FIG. 2 that the two half shells 5a, 5b have an L-shaped cross-section.

As is plain from FIG. 2 and FIG. 3, in the respective half shell 5a, 5b, notches or recesses 8 as well as the accordingly designed lugs or tabs 9 are provided, which engage with the recesses 8 on the opposite half shell, and thus ensure that the two half shells 5a, 5b remain joined in position, which is a great advantage for an automated production process. It is also evident from FIG. 3 how the two half shells 5a, 5b based on the respective semicircular channel sections 6a, 6b form the channel 6 for the fuse element 2, in that the fuse element 2 is received in a form-fitting and gap-free manner.

In joined state, the two half shells 5a, 5b when necessary can be inseparably connected to one another by a fastening means. Preferably this is done by ultrasound welding. During welding of the half shells 5a, 5b, the interior space 14 can when necessary be made even more pressure-stable.

Connecting of the ends 15a, 15b of the fuse element 2 to the respective end cap 4 preferably is carried out by indirect laser soldering. Although the connection can also be made by resistance soldering or induction soldering. The soldering is preferably without filler metal, so that production of organic compounds is avoided. Even the otherwise necessary use of high-melting brazing material based on PbSnAg or PbAg-base can be avoided.

In joined state of the two half shells 5a, 5b, the end caps 4 are pushed up and as already described, crimped with the insulating body 3. The finished fuse component 1 of the present invention has a cuboid shape, as may be seen in FIG. 4.

The present invention makes it possible to provide a novel fuse component with arc-controlling properties as well as especially simple and automated installation with avoidance of additional materials such as solder and extinguishing media. The design also makes scaling possible, so that smaller, in particular shorter housing dimensions can be achieved in a simple manner. The present invention therefore constitutes a quite special further development of the existing prior art, and furthermore makes it possible to specify, apart from a rated breaking capacity for AC, also a similar one for DC. The entire structural design effects a limitation of the arc phase under an applied/driving source voltage, and is thus not dependent on the zero point passages of the source voltage. In this regard, the focus of application of this fuse design lies in the DC range of the application plane. Furthermore, no further extinguishing media are necessary, so that through thermal insulation of the fuse element to the insulation housing, a slow-blow fusing characteristic can be achieved.

### LIST OF REFERENCE SYMBOLS

1 fuse component
2 fuse element
3 insulating body
4 end cap
5a half shell
5b half shell
6 channel
7 step
8 recess
9 tab
10 depression
11 lug
12 mounting surface
13 region
14 cavity
15a fuse element end
15b fuse element end

1-19. (canceled)

20. A fuse component comprising:
a fuse element;
an insulating body, wherein the fuse element is located inside the insulating body and the fuse element extends between two end faces of the insulating body;
the end faces of the insulating body are each closed with electrically conducting end caps and the end caps are in electrical contact with the fuse element,
the insulating body at least in a region of the end caps comprises two shells and the shells form a channel in an assembled state, the channel receiving the fuse element;
the channel runs parallel to a longitudinal axis of the insulating body;
the shells in the assembled state are fixed by at least one step axially with respect to one another;
wherein each shell has a substantially L-shaped cross-section transverse to the longitudinal axis; wherein a lug provided on one shell engages a recess provided on the other shell, and wherein the recess comprises a groove extending along a portion of a circumference transversely to the longitudinal axis of the fuse component on end regions of the half shells.

21. The fuse component according to claim 20, wherein the insulating body is built from at least two longitudinally running shells.

22. The fuse component according to claim 20, wherein the shells possess an interlocking shape.

23. The fuse component according to claim 20, wherein the shells are injection-molded parts.

24. The fuse component according claim 20, wherein the shells have an identical shape.

25. The fuse component according to claim 20, wherein the fuse element has angled ends.

26. The fuse component according to claim 25, wherein a respective end of the fuse element is in a press seat between the face-side inner wall of the respective cap and the respective end surface of the insulating body.

27. The fuse component according to claim 20, wherein the end cap and the insulating body are connected by crimping.

28. The fuse component according to claim 20, wherein the channel receives the fuse element in a gap-free manner.

29. The fuse component according to claim 20, wherein the end cap and the fuse element are electrically contacted to one another by laser soldering, resistance soldering, or induction soldering.

30. The fuse component according to claim 20, wherein a high direct current voltage rated breaking capacity is present without the use of additional extinguishing media.

31. The fuse component according to claim 20, wherein the end caps and the insulating body at least substantially form a plane and ensure a planar placement on circuit boards.
